(19) United States
(12) Patent Application Publication
(10) Pub. No.: US 2017/0371980 A1
(43) Pub. Date: Dec. 28, 2017

(54) MULTIPLE PLY LAYERED COMPOSITE HAVING LOW AREAL WEIGHT

(71) Applicant: SABIC Global Technologies B.V., Bergen op Zoom (NL)

(72) Inventors: Dharik Mallapragada, Houston, TX (US); Theofanis Theofanous, Sugar Land, TX (US); Nikhil Verghese, Sugar Land, TX (US)

(21) Appl. No.: 15/533,704

(22) PCT Filed: Aug. 10, 2016
(86) PCT No.: PCT/US2016/046360

§ 371 Date: Jun. 7, 2017

Related U.S. Application Data
(60) Provisional application No. 62/203,539, filed on Aug. 11, 2015.

(51) Int. Cl. G06F 17/50; B29C 65/00; B32B 41/00

(52) U.S. Cl. CPC G06F 17/50; B32B 41/00; B29C 66/967; G06F 2217/10; G06F 2217/44; G06F 2217/08

(57) ABSTRACT

A global optimization tool may be used to predict characteristics of a multiple ply layered composite as a condition of one or more continuous variables and/or one or more binary variables. For example, the global optimization tool may predict characteristics of a composite for a large range of fiber orientation angles of each of layer of the ply. The optimization tool may include solving a mixed integer nonlinear programming (MINLP) model to obtain a multiple ply layered composite design that is optimized relative to objectives, such as areal weight and cost. Thus, the global optimization tool may be able to identify composite designs with lower areal weight and/or lower cost than the composite designs identified by prior art trial and error methods or heuristic algorithms. When a composite design is identified as meeting certain criteria that are input to the global optimization tool, that composite design may be manufactured.

### CROSS-REFERENCE TO RELATED APPLICATIONS

This application claims the benefit of priority of U.S. Provisional Patent Application No. 62/203,539, filed Aug. 11, 2015, which is hereby incorporated by reference in its entirety.

### FIELD OF THE DISCLOSURE

The instant disclosure relates to multiple ply layered composites. More specifically, this disclosure relates to design and manufacturing of multiple ply layered composites with lower areal weight and/or cost.

### BACKGROUND

Fiber-reinforced composites can provide lower weight density and greater mechanical stiffness and strength compared to conventional structural materials like metals and ceramics. To date, fiber-reinforced composites have primarily found use in defense and aerospace sectors, where weight reduction without compromising mechanical performance is the predominant concern. Beyond these applications, there is growing interest to replace metals with fiber-reinforced composites as structural materials in large volume applications like automotive manufacturing. This growing interest is due to several factors, including the need to reduce environmental footprint and meet consumer expectations regarding weight of the materials. One feature of fiber-reinforced composites compared to metals is an inherent anisotropic mechanical response that allows composites to be tailored for specific applications. In particular, the aggregated nature of the composite provides numerous material and geometric degrees of freedom to a designer, which can be used for reduce the weight of the composite.

However, the aggregated nature of the composite also presents challenges to the design and manufacture of composites. In non-composite systems, the selection of materials involves usually only a single variable: the material. That is, when metals are chosen for a system, a designer has only to select one metal from a limited number of metals available for use. Metals are generally not layered together. Although metals can be alloyed together, there are standard alloys for purchase off the market. Further, even if metals are to be layered together, the individual layers have limited selections compared to composites. For example, the fibers in each layer of a composite material can be oriented in different directions. Metals are isotropic, and thus there is no preferred direction with which to orient a metal layer. Thus, conventional materials tools for designing systems are of little assistance to a composite designer.

Designers have thus had to rely on trial-and-error composite design methods that make use of prior experience or heuristics combined with experimental testing. These design methods are resource intensive and impose practical limitations on the number of designs that can be studied and tested. Thus, the resultant composite design produced by these design methods is very unlikely to be the best solution for any particular application. For example, the resultant composite may not have the lowest possible weight or cost for a particular application.

### SUMMARY

A better approach for the design of a multiple ply layered composite may allow selection from a variety of materials in a variety of configurations within the composite. However, the nearly unlimited selections available for materials and configuration of plies within a composite make simulating and/or optimizing composite designs inefficient. However, an optimization tool using certain models may be able to quickly screen for the composite designs with the optimal value of a certain attribute after systematically searching through the nearly endless selection of configurations available. A global optimization tool may be used to predict characteristics of a multiple ply layered composite as a condition of one or more continuous variables and/or one or more binary variables. For example, the global optimization tool may predict characteristics of a composite for a large range of fiber orientation angles of each of layer of the ply. Thus, the global optimization tool may be able to identify composite designs with lower areal weight and/or lower cost than the composite designs identified by prior art trial and error methods or heuristic algorithms. When a composite design is identified as meeting certain criteria that are input to the global optimization tool, that composite design may be manufactured.

In one embodiment, a mixed integer nonlinear programming (MINLP) model may be solved to obtain a multiple ply layered composite design with global optimization tools. The proposed MINLP model may include one or more of these features: i) the ability to choose from multiple fiber and resin materials for each ply, ii) discretized values of layer thicknesses in accordance with manufacturing limitations, and iii) ensuring the design does not exceed the practical strain and curvature limits imposed by the designer. In certain embodiments, the MINLP model may be extended to formulate a multi-objective optimization problem considering weight and a second objective that may represent the cost of manufacturing the composites.

According to one embodiment, a method may include receiving, by a processor, a plurality of input parameters specifying at least one material parameter of raw materials available for inclusion in the multiple ply layered composite and at least one material requirement of the multiple ply layered composite. The method may also include selecting, by the processor, at least two choices. In a first choice, the processor may select one or more materials for the multiple ply layered composite. In a second choice, the processor may select characteristics of individual layers within the multiple ply layered composite. The individual layer characteristics for the second choice may include fiber volume fraction and/or fiber orientation. The composite designed according to the first choice and the second choice selected by the processor may meet the at least one material requirement received by the processor as predicted by a composite property prediction model. The step of selecting the first choice and the second choice may include solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers. The step of selecting may also include optimizing a solution to the mixed integer nonlinear programming (MINLP) model to select the multiple ply layered composite meeting the at least one material requirement having a minimal areal weight.

According to another embodiment, an apparatus may include a memory and a processor coupled to the memory. The processor may be configured to perform the steps of receiving a plurality of input parameters specifying at least one material parameter of raw materials available for inclusion in the multiple ply layered composite and at least one material requirement of the multiple ply layered composite; and selecting a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement. The step of selecting may include solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers; and optimizing a solution to the mixed integer nonlinear programming (MINLP) model to select the multiple ply layered composite meeting the at least one material requirement having a minimal areal weight.

According to a further embodiment, a computer program product may include a non-transitory computer readable medium comprising code to perform the steps of receiving a plurality of input parameters specifying at least one material parameter of raw materials available for inclusion in the multiple ply layered composite and at least one material requirement of the multiple ply layered composite; and selecting a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement. The code to perform the step of selecting may include code to perform the steps of solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers; and optimizing a solution to the mixed integer nonlinear programming (MINLP) model to select the multiple ply layered composite meeting the at least one material requirement having a minimal areal weight.

In the context of the present invention, embodiments 1 to 39 are disclosed. Embodiment 1 is a method for designing a multiple ply layered composite, comprising: receiving, by a processor, a plurality of input parameters specifying at least one material parameter of raw materials available for inclusion in the multiple ply layered composite and at least one material requirement of the multiple ply layered composite; and selecting, by the processor, a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement, wherein the step of selecting comprises: solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers; and optimizing a solution to the mixed integer nonlinear programming (MINLP) model to select the multiple ply layered composite meeting the at least one material requirement having a minimal areal weight. Embodiment 2 is the method of embodiment 1, further comprising manufacturing the multiple ply layered composite selected according to the optimized solution to the mixed integer nonlinear programming (MINLP) model. Embodiment 3 is the method of embodiment 1, wherein the step of optimizing a solution to the mixed integer nonlinear programming (MINLP) model comprises: defining a vector of constraint functions, g and h, by selecting values for a vector of continuous decision variables, x, and a vector of binary decision variables, y, wherein the constraint functions comprise at least one of functions for calculating the constitutive mechanical properties of each possible pair of fiber and matrix that can form an individual ply, functions for calculating a composite mechanical property, and a linear loading-deformation relation governing an aggregated mechanical response of the composite; and defining an objective function, f, that is to be minimized while satisfying the constraint functions. Embodiment 4 is the method of embodiment 3, wherein the binary decision variables comprise at least one of presence or absence of a particular ply in the composite, total number of plies, thickness of each ply, fiber and resin material combination for each ply, and quadrant of a fiber orientation angle for each ply. Embodiment 5 is the method of embodiment 3, wherein the continuous decision variables comprise at least one of thickness and volume fraction of each ply, a vector of strains and curvatures experienced at a mid-plane of the composite, and variables to model certain trigonometric functions of the fiber orientation angle of each ply. Embodiment 6 is the method of embodiment 1, wherein the step of optimizing the solution comprises optimizing for multiple objectives, wherein the objectives comprise at least one of a physical attribute of the composite and a cost of the composite. Embodiment 7 is the method of embodiment 6, wherein the at least one physical attribute comprises at least one of a weight, a thickness, and a total fiber content of the multiple ply layered composite. Embodiment 8 is the method of embodiment 1, wherein the step of optimizing the solution comprises optimizing the solution with a branch-and-bound based global optimization solver executed by the processor. Embodiment 9 is the method of embodiment 1, wherein the at least one materials requirements comprises at least one of matrix, fiber, maximum strain, symmetric composite, balanced composite, ply thickness, maximum number of plies, in-plane forces, bending moments, twisting moments, strains, and deflections. Embodiment 10 is the method of embodiment 1, wherein the characteristics of individual layers comprise at least a thickness of each ply, a position of each ply relative to a mid-plane of the composite, an allowable volume fraction of fibers in each ply, and a fiber orientation angle in each ply. Embodiment 11 is the method of embodiment 1, wherein predicting the aggregated stiffness of the multiple ply layered composite comprises predicting the aggregated stiffness according to classical lamination theory (CLT). Embodiment 12 is the method of embodiment 1, wherein the step of optimizing the solution comprises predicting an aggregated stiffness of various composites comprising multiple fiber materials and multiple resin materials for each ply of the multiple ply layered composite. Embodiment 13 is the method of claim 1, wherein the step of optimizing the solution comprises selecting the one or more materials for the multiple ply layered composite and the characteristics of the individual layers of the multiple ply layered composite with the least weight among all the composites satisfying all the specified material requirements.

Embodiment 14 is an apparatus, comprising: a memory; and a processor coupled to the memory, wherein the processor is configured to perform the steps of: receiving a plurality of input parameters specifying at least one material parameter of raw materials available for inclusion in the multiple ply layered composite and at least one material requirement of the multiple ply layered composite; and selecting a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement, wherein the step of selecting comprises: solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers; and optimizing a solution to the mixed integer nonlinear programming (MINLP) model to select the multiple ply layered composite meeting the at least one material requirement having a minimal areal weight. Embodiment 15 is the apparatus of embodiment 14, wherein the processor is further configured to perform the step of outputting a data file comprising a description of the first choice of one or more materials for the multiple ply layered composite and the second choice of characteristics of individual layers within the multiple ply layered composite, wherein the description comprises the optimized solution to the mixed integer nonlinear programming (MINLP) model. Embodiment 16 is the apparatus of embodiment 14, wherein the step of optimizing a solution to the mixed integer nonlinear programming (MINLP) model comprises: defining a vector of constraint functions, g and h, by selecting values for a vector of continuous decision variables, x, and a vector of binary decision variables, y, wherein the constraint functions comprise at least one of functions for calculating the constitutive mechanical properties of each possible pair of fiber and matrix that can form an individual ply, functions for calculating a composite mechanical property, and a linear loading-deformation relation governing an aggregated mechanical response of the composite; and defining an objective function, f, that is to be minimized while satisfying the constraint functions. Embodiment 17 is the apparatus of embodiment 16, wherein the binary decision variables comprise at least one of presence or absence of a particular ply in the composite, total number of plies, thickness of each ply, fiber and resin material combination for each ply, and quadrant of a fiber orientation angle for each ply. Embodiment 18 is the apparatus of embodiment 16, wherein the continuous decision variables comprise at least one of thickness and volume fraction of each ply, a vector of strains and curvatures experienced at a mid-plane of the composite, and variables to model certain trigonometric functions of the fiber orientation angle of each ply. Embodiment 19 is the apparatus of embodiment 14, wherein the step of optimizing the solution comprises optimizing for multiple objectives, wherein the objectives comprise at least the one of a physical attribute of the composite and a cost of the composite. Embodiment 20 is the apparatus of embodiment 19, wherein the at least one physical attribute comprises at least one of a weight, a thickness, and a total fiber content of the multiple ply layered composite. Embodiment 21 is the apparatus of embodiment 14, wherein the step of optimizing the solution comprises optimizing the solution with a branch-and-bound based global optimization solver executed by the processor. Embodiment 22 is the apparatus of embodiment 14, wherein the at least one materials requirements comprises at least one of matrix, fiber, maximum strain, symmetric composite, balanced composite, ply thickness, maximum number of plies, in-plane forces, bending moments, twisting moments, strains, and deflections. Embodiment 23 is the apparatus of embodiment 14, wherein the characteristics of individual layers comprise at least a thickness of each ply, a position of each ply relative to a mid-plane of the composite, an allowable volume fraction of fibers in each ply, and a fiber orientation angle in each ply. Embodiment 24 is the apparatus of embodiment 14, wherein predicting the aggregated stiffness of the multiple ply layered composite comprises predicting the aggregated stiffness according to classical lamination theory (CLT). Embodiment 25 is the apparatus of embodiment 14, wherein the step of optimizing the solution comprises predicting an aggregated stiffness of various composites comprising multiple fiber materials and multiple resin materials for each ply of the multiple ply layered composite. Embodiment 26 is the apparatus of embodiment 14, wherein the step of optimizing the solution comprises selecting the one or more materials for the multiple ply layered composite and the characteristics of the individual layers of the multiple ply layered composite with the least weight among all the composites satisfying all the specified material requirements.

Embodiment 27 is a computer program product comprising code or computer program logic to perform the steps of: receiving a plurality of input parameters specifying at least one material parameter of raw materials available for inclusion in the multiple ply layered composite and at least one material requirement of the multiple ply layered composite; and selecting a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement, wherein the step of selecting comprises: solving a mixed integer nonlinear programming (MINLP) model by simultaneously considering the at least one material parameter and the characteristics of the individual layers and by predicting an aggregated stiffness of a composite having the considered at least one material parameters and the considered characteristics of the individual layers; and optimizing a solution to the mixed integer nonlinear programming (MINLP) model to select the multiple ply layered composite meeting the at least one material requirement having a minimal areal weight. In embodiment 27, the code or computer program logic may be stored on a non-transitory computer-readable medium.

Embodiment 28 is the computer program product of embodiment 27, wherein the medium further comprises code to perform the step of outputting a data file comprising a description of the first choice of one or more materials for the multiple ply layered composite and the second choice of characteristics of individual layers within the multiple ply layered composite, wherein the description comprises the optimized solution to the mixed integer nonlinear programming (MINLP) model. Embodiment 29 is the computer program product of embodiment 27, wherein the step of optimizing a solution to the mixed integer nonlinear programming (MINLP) model comprises: defining a vector of constraint functions, g and h, by selecting values for a vector of continuous decision variables, x, and a vector of binary decision variables, y, wherein the constraint functions comprise at least one of functions for calculating the constitutive mechanical properties of each possible pair of fiber and matrix that can form an individual ply, functions for calculating a composite mechanical property, and a linear loading-deformation relation governing an aggregated mechanical response of the composite; and defining an objective function, f, that is to be minimized while satisfying the constraint functions. Embodiment 30 is the computer program product of embodiment 29, wherein the binary decision variables comprise at least one of presence or absence of a particular ply in the composite, total number of plies, thickness of each ply, fiber and resin material combination for each ply, and quadrant of a fiber orientation angle for each ply. Embodiment 31 is the computer program product of embodiment 30, wherein the continuous decision variables comprise at least one of thickness and volume fraction of each ply, a vector of strains and curvatures experienced at a mid-plane of the composite, and variables to model certain trigonometric functions of the fiber orientation angle of each ply. Embodiment 32 is the computer program product of embodiment 27, wherein the step of optimizing the solution comprises optimizing for multiple objectives, wherein the objectives comprise at least the at least one material parameter and at least one of a physical attribute of the composite and a cost of the composite. Embodiment 33 is the computer program product of embodiment 32, wherein the at least one physical attribute comprises at least one of a weight, a thickness, and a total fiber content of the multiple ply layered composite. Embodiment 34 is the computer program product of embodiment 27, wherein the step of optimizing the solution comprises optimizing the solution with a branch-and-bound based global optimization solver. Embodiment 35 is the computer program product of embodiment 27, wherein the at least one materials requirements comprises at least one of matrix, fiber, maximum strain, symmetric composite, balanced composite, ply thickness, maximum number of plies, in-plane forces, bending moments, twisting moments, strains, and deflections. Embodiment 36 is the computer program product of embodiment 27, wherein the characteristics of individual layers comprise at least a thickness of each ply, a position of each ply relative to a mid-plane of the composite, an allowable volume fraction of fibers in each ply, and a fiber orientation angle in each ply. Embodiment 37 is the computer program product of embodiment 27, wherein predicting the aggregated stiffness of the multiple ply layered composite comprises predicting the aggregated stiffness according to classical lamination theory (CLT). Embodiment 38 is the computer program product of embodiment 27, wherein the step of optimizing the solution comprises predicting an aggregated stiffness of various composites comprising multiple fiber materials and multiple resin materials for each ply of the multiple ply layered composite. Embodiment 39 is the computer program product of embodiment 27, wherein the step of optimizing the solution comprises selecting the one or more materials for the multiple ply layered composite and the characteristics of the individual layers of the multiple ply layered composite with the least weight among all the composites satisfying all the specified material requirements.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an example multiple ply layered composite, such as a composite that may be designed with the disclosed optimization tool, according to one embodiment of the disclosure.

FIG. 2 is an example composite that may be designed with the disclosed optimization tool and directional components of moments (M) and force (N) resultants acting on the composite according to one embodiment of the disclosure.

FIG. 3 is a block diagram illustrating operation of an optimization tool implementing a MINLP modeling framework according to one embodiment of the disclosure.

FIG. 4 is a flow chart illustrating a method of selecting and manufacturing a composite panel with an optimization tool according to one embodiment of the disclosure.

FIG. 5 are graphs illustrating an improvement in composite material design possible with the MINLP model according to one embodiment of the disclosure.

FIG. 6 are graphs illustrating a pareto-optimal curve generated for a composite material design given certain input conditions and cost parameters according to one embodiment of the disclosure.

FIG. 7 is a block diagram illustrating operating an optimization tool for the design and manufacture of a composite panel according to one embodiment of the disclosure.

FIG. 8 is a schematic block diagram illustrating one embodiment of a computer system with processor that may execute certain embodiments of the optimization tool for designing composite panels.

### DETAILED DESCRIPTION

A multiple ply layered composite is a composite material having multiple layers, in which each layer includes fibers embedded in a resin to form a matrix. Each layer may be different materials or some or all layers may be made from the same material. Each of the layers may include different percentage fiber versus resin. Further, each layer may contain the fibers to be oriented at a different angle with respect to a fixed x-axis. Any one or all of these characteristics may be controlled in a design to change the characteristics of the resulting composite.

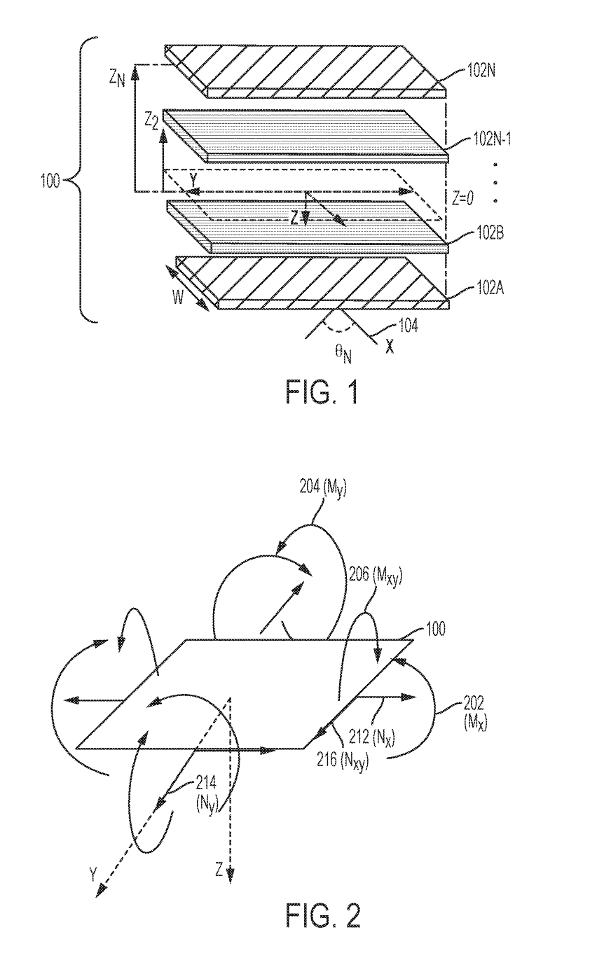

FIG. 1 is an example multiple ply layered composite, such as a composite that may be designed with the disclosed optimization tool, according to one embodiment of the disclosure. A composite panel 100 may include multiple layers 102A, 102B, . . . 102N (also referred to as plies), where each layer or ply i, may be defined by different characteristics including material descriptors and geometric descriptors. For example, material descriptors for a ply may include choices of fiber and matrix material and their respective volume fractions, v_{f}. Geometric descriptors for each ply i may include ply thickness, hᵢ, position, zᵢ, and fiber orientation, θᵢ, with respect to a reference axis 104. For a given set of available materials and an external loading scenario, involving any combination of bending moments, shear, compressive or tensile stresses, there exist a large number of alternative feasible composite designs for composite panel 100. Of these, only one or a few designs achieve a threshold value of certain performance criteria such as cost, weight, strength, and/or other objectives and are thus of practical interest because of manufacturing limitations and/or requirements for the composite panel.

Individual layers of the composite panel 100 may include fibers dispersed in a resin/polymeric matrix. Such composite materials are useful in various commercial products such as consumer electronics, ballistic, aeronautic, and transportation products. In one embodiment, the composite panel 100 may be a unidirectional (UD) layer or composite, in which the majority of fibers run substantially in one direction and provide anisotropic properties. Such anisotropic properties can be used to make articles of manufacture having unique desirable properties in one or more directions or dimensions. An example of a unidirectional composite is a unidirectional tape or prepreg that is commonly understood to be a thin strip or band of continuous unidirectional fibers (for instance glass fibers, carbon fibers, or other known reinforcing fibers) impregnated with a polymer resin. Some tapes can have a width in the order of magnitude of 1 to 15 cm wide, perhaps wider, and a thickness of less than 1 mm, such that the tape may be provided on a reel.

The polymeric matrix of the composite can include thermoplastic or thermoset polymers, co-polymers thereof, and blends thereof that are discussed throughout the present application. Non-limiting examples of thermoplastic polymers include polyethylene terephthalate (PET), a polycarbonate (PC) family of polymers, polybutylene terephthalate (PBT), poly(l,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polysulfone sulfonate (PSS), sulfonates of polysulfones, polyether ether ketone (PEEK), polyether ketone ketone (PEKK), acrylonitrile butyldiene styrene (ABS), polyphenylene sulfide (PPS), co-polymers thereof, or blends thereof. In addition to these, other thermoplastic polymers known to those of skill in the art, and those hereinafter developed, can also be used in the context of the present invention. In some aspects of the invention, the preferred thermoplastic polymers include polypropylene, polyamide, polyethylene terephthalate, a polycarbonate (PC) family of polymers, polybutylene terephthalate, poly(phenylene oxide) (PPO), polyetherimide, polyethylene, co-polymers thereof, or blends thereof. In more preferred aspects, the thermoplastic polymers include polypropylene, polyethylene, polyamide, a polycarbonate (PC) family of polymers, co-polymers thereof, or blends thereof The thermoplastic polymer can be included in a composition that includes said polymer and additives. Non-limiting examples of additives include coupling agents, antioxidants, heat stabilizers, flow modifiers, colorants, etc., or any combinations thereof.

Non-limiting examples of thermoset polymers that can be used to make a thermoset polymeric matrix include unsaturated polyester resins, polyurethanes, bakelite, duroplast, urea-formaldehyde, diallyl-phthalate, epoxy resin, epoxy vinylesters, polyimides, cyanate esters of polycyanurates, dicyclopentadiene, phenolics, benzoxazines, co-polymers thereof, or blends thereof. In addition to these, other thermoset polymers known to those of skill in the art, and those hereinafter developed, can also be used in the context of the present invention. The thermoset polymer can be included in a composition that includes said polymer and additives. Non-limiting examples of additives include coupling agents, antioxidants, heat stabilizers, flow modifiers, colorants, etc., or any combinations thereof.

The composite panel 100 may be incorporated into an article of manufacture having a constant cross-sectional profile or a non-constant cross-sectional profile. Non-limiting examples of articles of manufacture that can implement the composites of the present invention include automotive parts (e.g., doors, hoods, bumpers, A-beam, B-beam, battery casing, a body in white, a braided structure, a woven structure, a filament wound structure (e.g., pipes, pressure vessels, etc.), crush cans, front end modules, boot reinforcements, instrument panels, cross car beams, load floors, rail extensions, seat structures, suspensions, etc.), aircraft parts (e.g., wings, body, tail, stabilizer, etc.), wind turbine blades, bridges, boat hulls, boat decks, rail cars, pipes, pressure vessels, sporting goods, window lineals, tanks, pilings, docks, reinforced wood beams, retrofitted concrete structures, and/or reinforced extrusion or injection moldings. In other instances, the article of manufacture that can include the composites and laminates of the present invention can be an electronic part. Non-limiting examples of electronic parts include HDD (hard disk drive) casings, OLED TV structural supports, smartphone mid-frames, smartphone unibody casings, SSD (solid state drive) casings, tablet midframes, tablet unibody casings, TV stands or tables, UHD LED TV frames, lap-top computer casings, etc. Still further, the fiber-reinforced composites can be incorporated into ballistic applications, ropes and cables, protective apparel such as cut-resistant gloves, in life protection uses such as helmets, vehicular armoring, and plates, and as rubber reinforcement in tires, automotive hoses, fiber optic cables, textile processing, plastic reinforcement, and composites for marine sporting goods and aerospace applications, and the like.

FIG. 2 is an example composite that may be designed with the disclosed optimization tool and directional components of moment (M) and force (N) resultants acting on the composite according to one embodiment of the disclosure. The composite panel 100 may experience bending moments Mₓ 202 and M_{y} 204. Further, the composite panel 100 may experience forces Nₓ 212 and N_{y}, 214. Additional moments and forces may be experienced by the composite panel 100 in different directions. For example, the composite panel 100 may experience moment M_{xy} 206 and force N_{xy} 216. Requirements for a multiple ply layered composite may specify how the composite responds to moments 202, 204, and 206 and forces 212, 214, and 216. When materials are selected for the composite by an optimization tool, the characteristics of the composite panel and response to moments and forces may be predicted by the optimization tool.

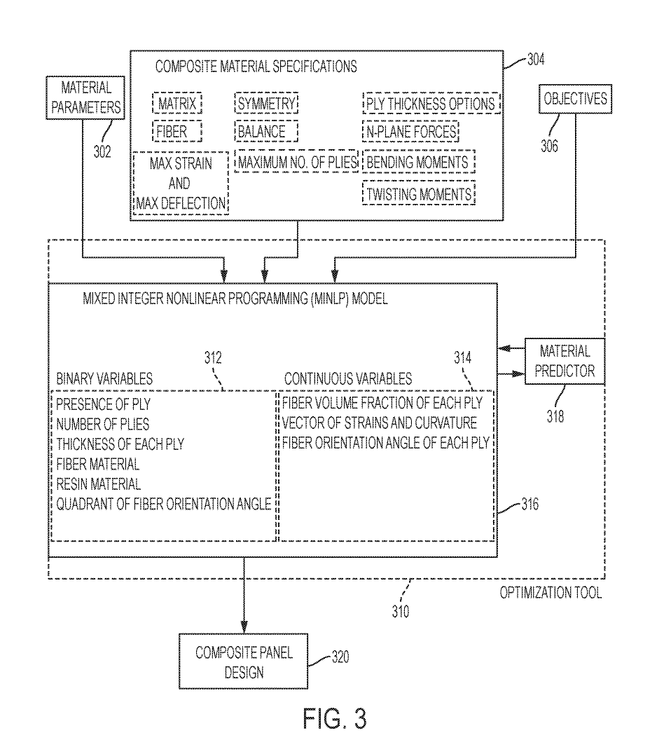

A mathematical model may be solved by an optimization tool to identify material descriptors and geometric descriptors for the composite panel 100. By applying a mathematical model, composite panels with optimal characteristics in view of input material requirements and other objectives, such as areal weight and cost, may be quickly identified without use of heuristics or trial-and-error manufacturing. FIG. 3 is a block diagram illustrating operation of an optimization tool implementing a MINLP modeling framework according to one embodiment of the disclosure. Material characteristics 302, materials specifications 304, and objectives 306 may be input to an optimization tool 310. Examples of the objectives 306 include areal weight and cost of the composite panel. Examples of materials specification 304 include end use loading and maximum deformation conditions and composite and layer characteristics, such as maximum number of plies, discretized layer thickness options, and v_{f}. Three examples of different sets of materials specifications 304 are provided in Table 1. Examples of material characteristics 302 include cost, density, and stiffness. Examples of material characteristics 302 are provided in Table 2.

TABLE 1
Three examples of materials requirements that may be input to an optimization tool
for generating a composite panel design.

| | | |
|---|---|---|
| Example 1 | Example 2 | Example 3 |

Loading conditions

| | | | |
|---|---|---|---|
| Forces (×10⁶ N m⁻¹) | — | [Nₓ N_{y}] = [0.30 0.07] | — |
| Moments (N) | [Mₓ M_{y}] = [1.5 1.5] | [Mₓ M_{y}M_{xy}] = [4 2 1] | [M_{y}] = [10] |
| Strain limit | — | \|[εₓ^{o} ε_{y}^{o}]\| ≦ [0.004 0.005] | — |
| Curvature limit (m⁻¹) | \|[Kₓ^{o} K_{y}^{o}]\| ≦ [1.5 1.5] | \|[Kₓ^{o} K_{y}^{o}]\| ≦ [2 1.5] | \|[Kₓ^{o} K_{y}^{o}]\| ≦ [0.5 0.5] |

Ply properties

| Number of plies | 8 | | 4 |
|---|---|---|---|
| Thickness (mm) | 0.05, 0.1, 0.2, 0.5 | | 0.25, 0.50, 0.75, 1.00 |
| v_{f} range | 0.4 ≦ v_{f} ≦ 0.65 | | 0.3 ≦ v_{f} ≦ 0.50 |
| Material | SGl/PP, SGl/Tor, | SGl/PP, SGl/Tor, | SGl/PP, T300/PC, |
| choice | T300/Epo, T300/PP, | SGl/Epo, T300/PP, | AS/PP, EGl/PC, |
| | AS/PP | T300/Tor, T300/Epo, | SGl/PC |
| | | AS/PP, AS/Tor, | |
| | | AS/Epo | |

TABLE 2
Example materials characteristics for input to an optimization tool
for generating an optimized composite panel design.

| | | Density (g | Stiffness, E_{f1}/E_{f2} or |
|---|---|---|---|
| Material | Cost ($ kg⁻¹) | cm⁻³) | Eₘ (GPa) |
| S-Glass | 10.0 | 2.49 | 85.5/85.5 |
| E-Glass | 2.0 | 2.49 | 73.1/73.1 |
| T300 (carbon fiber) | 25 | 1.77 | 220.6/13.8 |
| AS (carbon fiber) | 23 | 1.74 | 213.7/13.8 |
| Polypropylene (PP) | 2.4 | 0.9 | 1.20 |
| Polycarbonate (PC) | 4.2 | 1.1 | 2.3 |
| Torlon | — | 1.4 | 5.0 |

The optimization tool 310 may consider a number of decision variables in designing the composite panel, including binary variables 312 and/or continuous variables 314. The binary decision variables 312 may include: 1) the presence or absence of a ply layer in the optimal solution, 2) the total number of plies in composite, 3) the thickness of each ply from the available set of thicknesses that can be manufactured, 4) the tape for each ply from the available set of tapes, 5) the quadrant of the angle 2θᵢ corresponding to the values calculated for the trigonometric functions, and 6) fiber and resin materials selected from the list of available materials for each ply i. Although example variables are listed here, other variables may be input to the model and the optimization tool may consider the additional variables in formulating a composite panel 100. The continuous variables 314 may include: 1) fiber volume fraction of each ply i, v_{f,i}, 3) vector of strains and curvature predicted to be witnessed on imposing the specified loading condition on the composite panel, and 4) value of the fiber orientation angle, θᵢ of each ply, i.

The optimization tool 310 may solve a mixed integer nonlinear programming (MINLP) model 316 in view of the material characteristics 302 and the materials specifications 304 to find the optimal selections of the variables 312 and 314 that minimize the specified objective 306. For certain selection of values for the variables 312 and 314, the optimization tool 310 may execute a material predictor 318 to determine, for example, a strength of a composite panel constructed from those selected values to determine whether such a composite panel would withstand the materials requirements 304. The output of the optimization tool 310 may be a composite panel design 320 that includes selected values for the variables 312 and 314 that produce an optimized composite panel in view of at least one objective 306 that meets the materials requirements 314. This output may include at least a first choice of one or more materials for the multiple ply layered composite and a second choice of characteristics of individual layers within the multiple ply layered composite.

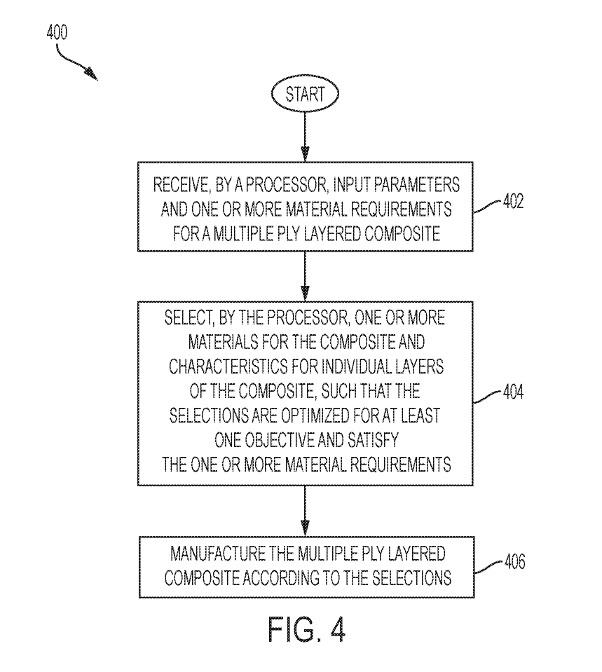

FIG. 4 is a flow chart illustrating a method of selecting and manufacturing a composite panel with an optimization tool according to one embodiment of the disclosure. A method 400 may begin at block 402 with receiving, by a processor, a plurality of input parameters specifying at least one material parameter of raw materials available for inclusion in the multiple ply layered composite and at least one material requirement of the multiple ply layered composite. Then, at block 404, the method 400 may include selecting, by the processor, a first choice of one or more materials for the multiple ply layered composite and a second choice of characteristics of individual layers within the multiple ply layered composite, wherein the individual layer characteristics comprise at least fiber volume fraction and fiber orientation angle, and wherein the first choice and the second choice meets the at least one material requirement. Finally, at block 406, the method 400 may include manufacturing the multiple ply layered composite selected according to the optimized solution to the mixed integer nonlinear programming (MINLP) model.

Referring back to block 404, the processor may solve a mathematical model to perform the selection of the first choice of materials and the second choice of layer characteristics. For example, the selection step may include the steps of solving a mixed integer nonlinear programming (MINLP) model by simultaneously considering the at least one material parameter and the characteristics of the individual layers and by predicting an aggregated stiffness of a composite having the considered at least one material parameter and the considered characteristics of the individual layers. The selection step 404 may also include optimizing a solution to the mixed integer nonlinear programming (MINLP) model to select the multiple ply layered composite meeting the at least one material requirement having a minimal areal weight. Although only a single objective, areal weight, is described in the method 400, other objectives or combinations of multiple objectives may be considered as part of the optimization process for designing and manufacturing a composite panel.

During the optimization process, qualities of a composite panel for certain selected materials and geometric descriptors may be predicted to determine whether a certain composite panel would meet the input material requirements. For example, an aggregated stiffness may be predicted for a designed composite to determine whether the composite would satisfy certain moment and force requirements. In one embodiment, qualities of a composite, such as aggregate stiffness may be predicted using classical lamination theory (CLT).

Classical lamination theory (CLT) provides a prediction of the constitutive behavior of composite materials under planar mechanical loading by aggregating the forces and moments experienced throughout the composite at the mid-plane of the structure. For example, referring back to FIG. 1, a composite panel 100 may include 2N plies arranged in a symmetric manner about a z=0 mid-plane. A composite plate under planar mechanical loading may experience different axial forces and moments, which are incorporated within CLT in the form of resultants acting on the mid-plane (z=0). The resultants of force (Nₓ, N_{y}, N_{xy}) and moments (Mₓ, M_{y}, M_{xy}) may be calculated on a per unit width basis by integrating the individual ply stresses over the composite thickness. For a symmetric composite, the six mid-plane loads for force N and moments M may be related to the deformation of the composite at the mid-plane by three strains ∈ₓ^{o}, ∈_{y}^{o}, ∈_{xy}^{o} and three deflections κₓ^{o}, κ_{y}^{o}, κ_{xy}^{o} through the equations:

$$[ \begin{matrix}{N}_{x} \\ {N}_{y} \\ {N}_{xy}\end{matrix} ] = [ \begin{matrix}{A}_{11} & {A}_{12} & {A}_{16} \\ {A}_{12} & {A}_{22} & {A}_{26} \\ {A}_{16} & {A}_{26} & {A}_{66}\end{matrix} ] [ \begin{matrix}{ɛ}_{x}^{o} \\ {ɛ}_{y}^{o} \\ {ɛ}_{xy}^{o}\end{matrix} ] \\ [ \begin{matrix}{M}_{x} \\ {M}_{y} \\ {M}_{xy}\end{matrix} ] = [ \begin{matrix}{D}_{11} & {D}_{12} & {D}_{16} \\ {D}_{12} & {D}_{22} & {D}_{26} \\ {D}_{16} & {D}_{26} & {D}_{66}\end{matrix} ] [ \begin{matrix}{κ}_{x}^{o} \\ {κ}_{y}^{o} \\ {κ}_{xy}^{o}\end{matrix} ] ,$$

where Apq and Dpq refer to the in-plane and out-of-plane components of the laminate stiffness matrix, respectively, and are explicit functions of geometric and material descriptors of the composite. In one embodiment, A_{pq} and D_{pq} may be calculated from the following equations:

$${A}_{pq} = 2 {\sum }_{i = 1}^{N} {\overline{Q}}_{pq}^{i} ( {z}_{i} - {z}_{i - 1} ) ∀ p = 1 , 2 , 6 , q = 1 , 2 , 6$$

$${D}_{pq} = \frac{2}{3} {\sum }_{i = 1}^{N} {\overline{Q}}_{pq} ( {z}_{i}^{3} - {z}_{i - 1}^{3} ) ∀ p = 1 , 2 , 6 , q = 1 , 2 , 6 ,$$

where A_{pq} and D_{pq} are defined as a summation of the transformed stiffness matrix for each ply i, Q_{pq}ⁱ with each weighted by a respective ply geometric factor.

For each ply i within the composite, the dependence of the transformed stiffness matrix on the fiber orientation, θᵢ may be calculated from the following equation:

$$[ \begin{matrix}{\overline{Q}}_{11}^{i} \\ {\overline{Q}}_{12}^{i} \\ {\overline{Q}}_{22}^{i} \\ {\overline{Q}}_{16}^{i} \\ {\overline{Q}}_{26}^{i} \\ {\overline{Q}}_{66}^{i}\end{matrix} ] = [ \begin{matrix}1 & cos 2 {θ}_{i} & cos 4 {θ}_{i} & 0 \\ 0 & 0 & - cos 4 {θ}_{i} & 1 \\ 1 & - cos 2 {θ}_{i} & cos 4 {θ}_{i} & 0 \\ 0 & \frac{1}{2} sin 2 {θ}_{i} & sin 4 {θ}_{i} & 0 \\ 0 & \frac{1}{2} sin 2 {θ}_{i} & - sin 4 {θ}_{i} & 0 \\ \frac{1}{2} & 0 & - cos 4 {θ}_{i} & - \frac{1}{2}\end{matrix} ] [ \begin{matrix}{U}_{i}^{1} \\ {U}_{i}^{2} \\ {U}_{i}^{3} \\ {U}_{i}^{4}\end{matrix} ] ∀ i ∈ {W}^{ply} .$$

For a fixed ply material composition, Uᵢ¹ to Uᵢ⁴, referred to as the material invariants, may be constants that are defined by the following equations as a linear combination of the components of the ply stiffness matrix at θᵢ=0, Q_{pq}ⁱ:

Uᵢ¹=⅛(3Q₁₁ⁱ+3Q₂₂ⁱ+2Q₁₂ⁱ+4Q₆₆ⁱ)∀i ∈ W^{ply}

Uᵢ²=½(Q₁₁ⁱ−Q₂₂ⁱ)∀i ∈ W^{ply}

Uᵢ³=⅛(Q₁₁ⁱ+Q₂₂ⁱ−2Q₁₂ⁱ−4Q₆₆ⁱ)∀i ∈ W^{ply}

Uᵢ⁴=⅛(Q₁₁ⁱ+Q₂₂ⁱ+6Q₁₂ⁱ−4Q₆₆ⁱ)∀i ∈ W^{ply}.

For each ply i, the value of Q_{pq}ⁱ may be related to the effective mechanical properties obtained from experimental characterization of the ply material, namely the stiffness modulus along (E₁) and perpendicular (E₂) to the fiber, Poisson's ratio (v₁₂), and the shear modulus (G₁₂) as shown in the equations below:

$${Q}_{11}^{i} = \frac{{( {E}_{1}^{i} )}^{2}}{( {E}_{1}^{i} - {E}_{2}^{i} {v}_{12}^{i} )}$$

$${Q}_{22}^{i} = \frac{{E}_{1}^{i} {E}_{2}^{i}}{( {E}_{1}^{i} - {{E}_{2}^{i} ( {v}_{12}^{i} )}^{2} )}$$

$${Q}_{12}^{i} = \frac{{v}_{12}^{i} {E}_{1}^{i} {E}_{2}^{i}}{( {E}_{1}^{i} - {{E}_{2}^{i} ( {v}_{12}^{i} )}^{2} )}$$

$${Q}_{66}^{i} = {G}_{12}^{i} .$$

These effective mechanical properties of the ply may be further related to the constitutive properties of the fiber and matrix and their relative volume fractions v_{f} through empirical micromechanical models. For example, the longitudinal stiffness modulus (E₁) and the transverse modulus (E₂) of the ply may be related to corresponding properties of the anisotropic fiber (E_{f1}, E_{f2}) and isotropic matrix (Eₘ) through the following equations:

$${E}_{1}^{i} = {E}_{f 1} {v}_{f , i} + {E}_{m} ( 1 - {v}_{f , i} ) ∀ i ∈ {W}^{ply}$$

$${E}_{2}^{i} = \frac{{E}_{m}}{1 - \sqrt{{v}_{f , i}} ( 1 - \frac{{E}_{m}}{{E}_{f 2}} )} ∀ i ∈ {W}^{ply} .$$

Similar calibrated relationships may be calculated for other ply properties, such as shear modulus (G₁₂) and Poisson's ratio (v₁₂).

Conventional composite design optimization tools, such as those described above in the background section, assume a fixed material composition of each ply, such as by fixing the Uᵢ¹ to Uᵢ⁴ parameters described above. Thus, such optimization tools do not include calculations for variables Uᵢ¹-Uᵢ⁴, Q₁₁ⁱ, Q₂₂ⁱ, Q₁₂ⁱ, Q₆₆ⁱ, E₁ⁱ, and E₂ⁱ. The optimization tool of the present invention, as illustrated in a non-limiting embodiment in FIG. 3, instead allows selection from more than one combination of fiber and matrix parameters or ply material, for each ply i. Additionally, the optimization tool of the present invention may also consider variability in v_{f} over a defined range of interest.

In one embodiment, the optimization tool may limit certain calculations of the non-linear relationships described above between Q_{pq} and v_{f} that is valid for all values of 0≦v_{f}≦1 to certain ranges of v_{f} by using a surrogate polynomial function of v_{f} that is valid over a defined range of 0≦v_{f,L}≦v_{f}≦v_{f,U}≦1. For each tape, the model parameters α_{pq}, β_{pq}, and γ_{pq} may be obtained after regressing the model against the output of the original micromechanical models for the feasible v_{f} values.

In selecting parameters for a composite panel the optimization tool may select a particular number of plies that is less than the maximum number of allowable plies, 2N, that should be included in an optimized composite design. For a fixed N, the binary variable yⱼ^{N}, selects the total number of plies that are in the optimal design for a composite. For example, y₃⁵=1 indicates that a composite with six plies is selected from a design space that allows a maximum of ten plies. The following equation may be defined within the optimization tool to enforce a restriction on selecting a composite with a fixed total number of plies that is less than the maximum number of allowable plies, 2N:

$${\sum }_{j = 1}^{N} {y}_{j}^{N} = 1.$$

Additional constraints in the following equations may be defined within the optimization tool to enforce which plies are present or absent in each case with different total numbers of plies:

yⱼ^{N}≦yᵢ∀i≦j, j=1, . . . , N

1−yⱼ^{N}≧yᵢ∀i>j, i, j=1, . . . , N.

For example, in the case of y₃⁵=1, the above equations enforce the first three plies to be present (y₁=y₂=y₃=1 and y₄=y₅=0).

In selecting parameters for a composite, the optimization tool may select thicknesses for each ply i from a continuous variable hᵢ. The thickness of each existing ply may be selected from the set of possible values W^{th} according to constraints of the following equations:

$${h}_{i} = {\sum }_{r ∈ {W}^{th}} {h}_{r}^{geo} {y}_{i , r}^{geo} ∀ i = 1 , … , N$$

$${\sum }_{r ∈ {W}^{th}} {y}_{i , r}^{geo} = {y}_{i} ∀ i = 1 , … , N$$

$${h}_{i} \geq {min}_{r ∈ {W}^{th}} ( {h}_{r}^{geo} ) {y}_{i} ∀ i = 1 , … , N$$

$${h}_{i} \leq {max}_{r ∈ {W}^{th}} ( {h}_{r}^{geo} ) {y}_{i} ∀ i = 1 , … , N ,$$

where the last two constraints may impose upper and lower bounds on the thickness variables. The z coordinate of each ply may be related to the thickness variables according to the following equation and bounded accordingly:

zᵢ=−Σ_{i′≦i}h_{i′} ∀i=1, . . . , N.

For each existing ply (where yᵢ=1), the following equation applied by the optimization tool to enforces the selection of a single ply material from the given set of ply materials (i.e. combinations of fiber and resin), W^{tape}:

$${\sum }_{t ∈ {W}^{tape}} {y}_{i , t}^{mat} = {y}_{i} ∀ i = 1 , … , N .$$

The ply material invariants may be calculated by the optimization tool according to the following equation:

$${U}_{i}^{u} = {\sum }_{t ∈ {W}^{tape}} {y}_{i , t}^{mat} ( {\overline{U}}_{α , t}^{j} {v}_{f , i}^{2} + {\overline{U}}_{β , t}^{j} {v}_{f , i} + {\overline{U}}_{γ , t}^{j} )$$

$$∀ = 1 , … , N , u = 1 , 2 , 3 , 4 ,$$

where the parameters Ū_{α,t}^{u}, Ū_{β,t}^{u}, Ū_{γ,t}_{^{γ,t}}^{u} for each tape t may be derived as a linear combination of the corresponding parameters in

Q_{pq}=α_{pq}v_{f}²+β_{pq}v_{f}+γ_{pq} ∀v_{f} ∈ [v_{f}^{L}, v_{f}^{U}]p, q=1,2,6.

For the ply materials investigated through the MNILP model, the coefficients of the polynomial expression for U_{i,u} are found to be such that the polynomial monotonically increases within the range 0≦v≦1. This observation, combined with the following bounds:

v_{f,i}≧v_{f}^{L}yᵢ ∀i=1, . . . , N

v_{f,i}≦v_{f}^{U}yᵢ ∀i=1, . . . , N.

may be used to define upper and lower bounding constraints for the material invariants as shown in the equations below:

$${U}_{i}^{u} \leq {max}_{t ∈ {W}^{tape}} ( {{\overline{U}}_{α , t}^{j} ( {v}_{f}^{U} )}^{2} + {\overline{U}}_{β , t}^{j} {v}_{f}^{U} + {\overline{U}}_{γ , t}^{j} ) {y}_{i}$$

$$∀ i = 1 , … , N , u = 1 , 2 , 3 , 4$$

$${U}_{i}^{u} \geq {min}_{t ∈ {W}^{tape}} ( {{\overline{U}}_{α , t}^{j} ( {v}_{f}^{L} )}^{2} + {\overline{U}}_{β , t}^{j} {v}_{f}^{L} + {\overline{U}}_{γ , t}^{j} ) {y}_{i}$$

$$∀ i = 1 , … , N , u = 1 , 2 , 3 , 4.$$

In selecting parameters for a composite the optimization tool may select angle ply constraints for each ply using a continuous variable, θᵢ and its corresponding trigonometric functions. For each existing ply, the decision variables representing the trigonometric functions may be defined by enforcing the known trigonometric identity relations as constraints shown in the equations below:

(Cᵢ^{4θ})²+(Sᵢ^{4θ})²=yᵢ ∀i=1, . . . , N,

2Cᵢ^{2θ}Sᵢ^{2θ}=Sᵢ^{4θ} ∀i=1, . . . , N,

2(Cᵢ^{2θ})²−yᵢ=Cᵢ^{4θ} ∀i=1, . . . , N,

(C̅_{i,k}^{2θ})²+(S̅_{i,k}^{2θ})²=y_{i,k}^{2θ} ∀i=1, . . . , N, K=1,2,3,4.

The solution satisfying the trigonometric identities, however, may not correspond to a unique value of θᵢ, due to possibility of an incorrect sign convention arising from the bilinear nature of terms involved (e.g. sin² 2θᵢ, cos² 2θᵢ, sin 2θᵢ, cos 2θᵢ). To eliminate solutions of the trigonometric identities that do not correspond to a unique value of 2θᵢ, the feasible region of 2θᵢ may be partitioned into four quadrants, using a convex hull reformulation.

For each existing ply i, if the binary variable y_{i,k}^{2θ}=1, then 2θᵢ belongs to the k^{th} quadrant determined by the following equation:

$${\sum }_{k = 1}^{4} {y}_{i , k}^{2 θ} = {y}_{i} ∀ i = 1 , … , N .$$

The sine and cosine variables may be enforced with an appropriate sign convention. For example, if 2θᵢ is in the second quadrant or k=2, then cosine and sine variables are enforced to be negative and positive, respectively. Finally, all the sine and cosine decision variables for the existing plies may be bounded to have an absolute value of unity.

In selecting parameters for a composite the optimization tool may apply mechanical response constraints during the optimization. The in-plane (A_{pq}) and out-of-plane (D_{pq}) components of the stiffness matrix may be reformulated in terms of hᵢ and included in the model as the following equations:

$${A}_{pq} = 2 {\sum }_{i = 1}^{N} {\sum }_{r ∈ {W}^{th}} {\overline{Q}}_{pq}^{i} {h}_{r}^{geo} {y}_{i , r}^{geo} ∀ p = 1 , 2 , 6 , q = 1 , 2 , 6$$

$${D}_{qp} = {\sum }_{i = 1}^{N} ( \frac{2}{3} {\overline{Q}}_{pq}^{i} {h}_{i}^{3} + 2 {\overline{Q}}_{pq}^{i} {h}_{i}^{2} {z}_{i} + 2 {\overline{Q}}_{pq}^{i} {h}_{i} {z}_{i}^{2} )$$

$$∀ p = 1 , 2 , 6 , q = 1 , 2 , 6.$$

The optimization tool may enforce certain materials requirements while solving an MNLIP model, such as the embodiment described in the equations above. For example, to enforce selection of a balanced composite by the optimization tool, the tool may enforce the following equation:

A_{pq}=0 ∀ (p, q)=[(1,6), (2,6)],

which imposes the components A₁₆ and A₂₆ to be zero. Additionally, the optimization tool may enforce non-negativity of the components of the composite stiffness matrix and ply stiffness matrix, respectively, with the following equations:

A_{pq}, D_{pq}≧0 ∀ (p, q)=[(1,1) , (1,2) , (2,2) , (6,6)]

Q̅_{pq}ⁱ≧0 ∀ i=1, . . . , N, (p, q)=[(1,1), (1,2), (2,2), (6,6)].

Another constraint that may be imposed by the optimization tool includes user-specified maximum permissible values of the mid-plane strains (∈ᵢᵢ;ii=1, 2, 3) and curvatures (∈ᵢᵢ;ii=4, 5, 6). This constraint may be enforced by optimization tool using the following equations, which allow for positive and negative values of the maximum deformations:

∈ᵢᵢ≦|∈ᵢᵢ^{max}| ∀ ii=[1, . . . , 6]

∈ᵢᵢ≧−|∈ᵢᵢ^{max}| ∀ ii=[1, . . . , 6].

The optimization tool may design composite materials that meet input materials requirements and optimize the designed material in view of one or more objectives, such as areal weight and/or cost. These objectives may be defined in the optimization tool as objective functions. In one embodiment, the MINLP model may be solved to minimize the areal weight of the laminated composite, Obj_{weight}, defined by the following equation as the summation of the areal weights of the constituent plies in g m⁻²:

$${Obj}_{weight} \times {10}^{- 3} = 2 {\sum }_{i = 1}^{N} {\sum }_{t ∈ {W}^{tape}} ( ( {ρ}_{f , t} - {ρ}_{m , t} ) {v}_{f , i} {y}_{i , t}^{mat} {h}_{i} + {ρ}_{m , t} {y}_{i , t}^{mat} {h}_{i} ) .$$

In this equation, the density of each ply is dependent on the choice of ply material selected and v_{f,i}.

The MINLP model with certain of the constraints described above may be solved using a global optimization algorithm such as the type implemented in the commercially-available BARON solver. The MINLP model may allow the selection of materials and characteristics for layers of a composite model from an extremely large range of options. For example, in one test case involving nine possible ply materials, four possible ply thicknesses, and up to eight possible plies, the MINLP model consisted of 76 binary and 134 continuous variables and 121 equality and 212 inequality constraints with 594 nonlinear terms. The number of permutations for each of these variables makes solution by manual effort impossible. Even under a brute force approach using a computer system, the optimal design of a composite based on this large number of permutations would be unrealistic. However, the MINLP model formulated as described above allows for designing of a composite material optimized based on certain objectives to meet certain materials requirements in a short period of time (<2 hours).

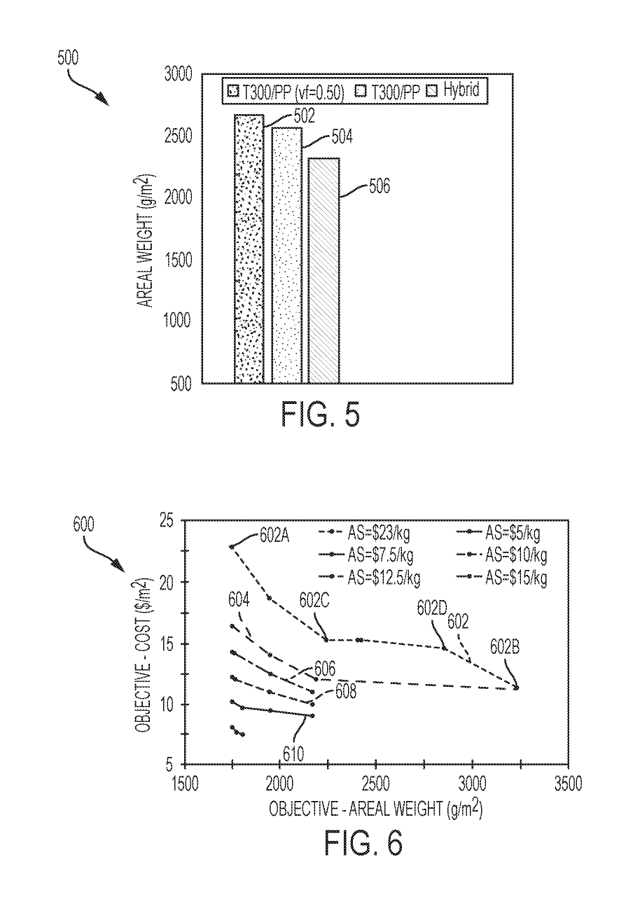

FIG. 5 are graphs illustrating an improvement in composite material design possible with the MINLP model according to one embodiment of the disclosure. Graphs 500 illustrates three outcomes for the areal weight of a composite designed to meet certain materials requirements. A bar 502 illustrates the areal weight of a composite material selected only from T300/PP material with a constant volume fraction of 0.50. A bar 504 illustrates the areal weight of a composite material selected only from T300/PP material with freedom of volume fraction v_{f} to vary between 0.4 to 0.65. A bar 506 illustrates the areal weight of a composite material selected from a hybrid of materials T300/PP and AS/PP. As shown between the bars 502, 504, and 506, increasing the freedom of design selection by adding additional variables to the model provides for an increased possibility of optimization in terms of reducing areal weight. The MINLP model described above allows consideration of these additional variables and optimization of the composite material design based on these additional variables in a manner that allows designs not previously contemplated due to the limits of the prior art heuristics and trial-and-error approaches. In fact, the MINLP model may allow selecting optimal materials and layer characteristics in a matter of a few minutes, despite a large number of variables.

Although the models described above include optimization of the composite material in view of one objective, areal weight, the optimization of the MINLP model in other embodiments may involve optimizing based on multiple objectives. For example, in addition to optimizing the composite design to obtain a composite that satisfies the materials requirements with the lowest areal weight, the optimization tool may optimize to obtain a trade-off between lowest areal weight and lowest cost.

A representative production cost function for the MINLP model with multi-objection optimization may be given by the following equation:

$${Obj}_{cost} \times {10}^{- 3} = 2 {\sum }_{i = 1}^{N} {\sum }_{t ∈ {W}^{tape}} ( ( {ρ}_{f , t} {C}_{f , t} - {ρ}_{m , t} {C}_{m , t} ) {v}_{f , i} {y}_{i , t}^{mat} {h}_{i} + {ρ}_{m , t} {C}_{m , t} {y}_{i , t}^{mat} {h}_{i} ) + 2 {C}_{angle} {\sum }_{i = 1}^{N} {\sum }_{t ∈ {W}^{tape}} ( ( {ρ}_{f , t} - {ρ}_{m , t} ) {v}_{f , i} {y}_{i , t}^{mat} {h}_{i} ( 1 - {y}_{i}^{deg} ) + {ρ}_{m , t} {y}_{i , t}^{mat} {h}_{i} ( 1 - {y}_{i}^{deg} ) ) ,$$

where the first summation represents the total raw material cost of the constituent plies of the composite, with C_{f,t} and C_{m,t} corresponding to the cost of fiber and matrix that make up ply material t, respectively, whereas the second summation is the cost associated with assembling plies with non-zero fiber orientation angles (θᵢ ≠ 0), where C_{angle} corresponds to the additional cost associated with assembling a ply with a non-zero θᵢ compared to a 0 degree ply.

The optimal solutions of the minimum cost MINLP model and the minimum weight MINLP model provide upper and lower bounds respectively, on the weight of a feasible composite design. The solution of the multi-objective optimization problem can then be obtained using the φ-constraint method, whereby the feasible region of one of the objectives (e.g. weight) is partitioned into intervals defined by the nodes φᵢ, i=1 . . . , n²⁷. At each node i, a cost optimization problem may be formulated and solved with the constraint that the optimal design has an areal weight lower than φᵢ.

When this procedure is repeated at each node φ₁ to φₙ, the resulting set of optimal solutions provide an approximation to the pareto-optimal curve for the two competing objectives. FIG. 6 are graphs 600 illustrating a pareto-optimal curve generated using nine nodal points for a composite material design given certain input conditions and cost parameters. For the base case cost parameters shown as line 602, the lowest cost design at point 602B and lowest weight design at point 602A utilize the least expensive and highest specific stiffness (stiffness per unit density) ply material, respectively. The minimum cost design places only two of the four plies along the direction of an load applied due to the additional cost associated with assembling plies at different angles other than zero (i.e. along x-axis). The base case pareto curve 602 also exhibits a relatively flat region with hybrid material design solutions at points 602C and 602D that utilize two plies each of a low cost material (E-Glass/PP) and a high cost material (AS/PP). Nonetheless, the weight reduction of up to 21% and cost increase of 5% in design 602C relative to design 602D is achieved by increasing the of in AS/PP plies from 30% to 46% while simultaneously reducing the thickness of the E-Glass/PP plies from 0.75 mm to 0.5 mm.

By changing the material costs parameters input to the MINLP model, a sensitivity analysis of the pareto-optimal curve to the cost of certain materials may be generated. Additional lines 604, 606, 608, 610, and 612 of FIG. 6 illustrate sensitivity to the optimal design based on the cost of AS carbon fiber. The sensitivity information may provide information about how a designed composite may change over time as, for example, materials cost increase or decrease. This sensitivity information may also be generated by the optimization tool 310 of FIG. 3.

Structural design using fiber-reinforced composite materials involves numerous geometric and material degrees of freedom that if selected judiciously, could result in significant weight reduction benefits compared to the use of metals, while achieving the same mechanical performance. Thus, composite panels can provide significant advantages to consumer goods when the materials and characteristics of individual layers of the composite panels are appropriately selected. For example, the composite panels may be installed as shells for electronic devices such as cellular phones and laptop computers. As another example, the composite panels may be installed as door panels and bumpers on automobile vehicles. However, the number of options available for the composite panels far exceed the number of options available for conventional materials. For example, for metals there are generally fewer parameters to consider. One reason for this is described above in that metals are isotropic rather than anisotropic. For a composite panel with multiple plies, each ply may have a different material and different characteristics. This freedom of design significantly increases the number of options and often results in suboptimal selection of those materials and layer characteristics because of an inability to make these selections in a systematic manner. Conventional design of composite materials rely on heuristics or trial-and-error, which provide sub-optimal designs. These sub-optimal designs for composite panels may not be competitive with conventional metal materials.

The use of an MINLP model as described above can identify the least weight composite structure that can withstand a given loading condition with resulting deformations that are within the prescribed limits. The model may be solved by incorporating certain constraints describing the mechanical response of composites under planar loading as well as the ply stiffness prediction as a function of the constituent fiber and matrix via micromechanical relations. For each ply, the model may consider many possible geometric descriptors as decision variables and also decision variables to select the ply material from the available set of materials and the ply v_{f}. Using the MINLP model makes it feasible to design composites that are made up of more than one fiber and/or more than one matrix material in order to achieve lower overall weight per unit area than a conventional composite that uses plies of a single fiber and a single matrix material. For loading scenarios involving bending, the composite design predicted by the MINLP model uses lower v_{f} in the inner plies (near the neutral axis) than the outer plies, which results in enhanced weight reduction (weight per unit area) while meeting the prescribed loading/deformation conditions. Further extensions of the model to consider competing objectives, such as production cost, result in the formulation of a multi-objective optimization problem, whose solution reveals an array of alternative solutions that can be later evaluated for their practicality.

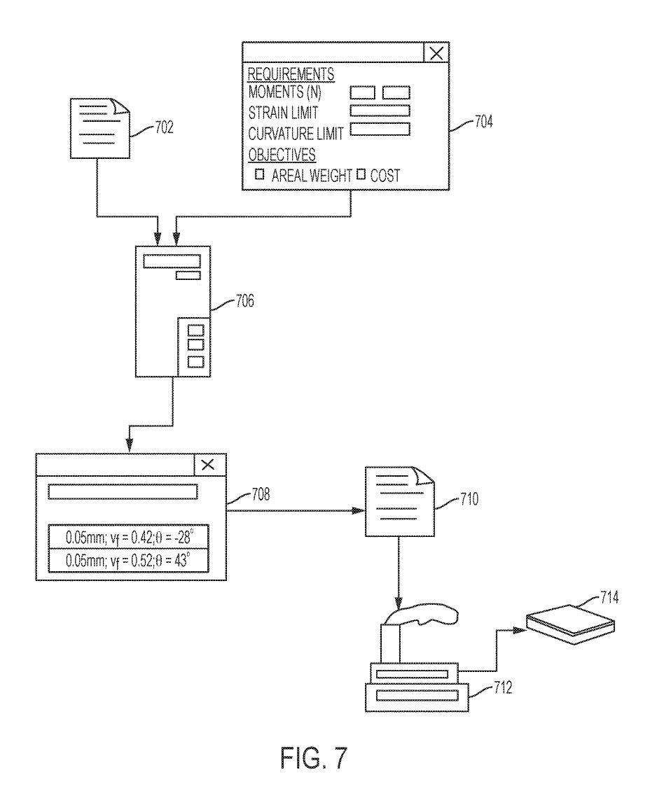

FIG. 7 is a block diagram illustrating operating an optimization tool for the design and manufacture of a composite panel according to one embodiment of the disclosure. A computer 706 having one or more processors (not shown) may execute code contained on a computer readable medium that executes an optimization tool, such as optimization tool 310 illustrated in FIG. 3. The computer 706 may receive an input file 702 containing materials parameters, such as materials parameters 302 of FIG. 3 also shown in Table 1. The input file 702 may be in the format of a text document with tab or comma delineators, an extensible markup language (XML) document, or a binary file such as spreadsheet. The computer 706 may also receive materials requirements through a user interface 704. The user interface 704 may allow a user to specify criteria for a composite panel design, such as moments, strain limits, curvature limits, etc. The user interface 704 may also allow a user to specify objectives for which to optimize the composite panel design, such as areal weight and cost. The user interface may directly interact with the optimization tool executing on computer 706, such as when the user interface 704 is a part of the software package for the optimization tool. In other embodiments, the user interface 704 may be presented on a remote device, such as a laptop, tablet, or cellular phone, that is communicating with the computer 706 over a network. The user interface 704 may be presented to a user as either a web page or a stand-alone application. When the user interface 704 is displayed on a remote device, the data input to the user interface 704, such as the materials requirements and objectives, may be formatted as an input file that is transmitted to the computer 706 over the network. The computer 706 may then parse the input file 702 and the input file generated by the user interface 704 to provide input to the optimization tool.

The optimization tool may then execute on the processor of the computer 706 and generate an output of at least one composite panel design meeting the materials requirements specified in the user interface 704. The one or more composite panel designs may be displayed in a user interface 708, such as by drawing the plies of the composite panel and presenting text within each of the drawn plies indicating the material and other parameters for that ply, such as volume fraction θ_{f} and fiber orientation angle. The user interface 708, like the user interface 704, may be presented to a user operating the computer 706 or to a remote user through a web-based display or stand-alone application. The data illustrated in the user interface 708 may be exported to a data file 710. In some embodiments, no user interface 708 is generated, and the output of the optimization tool executing on the computer 706 may be written directly to the data file 710.

The data file 710 may contain a text description of the composite panel designs and/or machine instructions that can be interpreted by manufacturing equipment at manufacturing facility 712. The manufacturing facility 712 may then produce a composite panel 714 according to the design specified in the data file 710 generated by the optimization tool executing on the computer 706. The data file 710 may include computed parameters and other parameters, including: layup, material for each layer, coordinates of locating each layer if the layer does not cover the whole area, processing method, time, temperature, pressure, and/or vacuum.

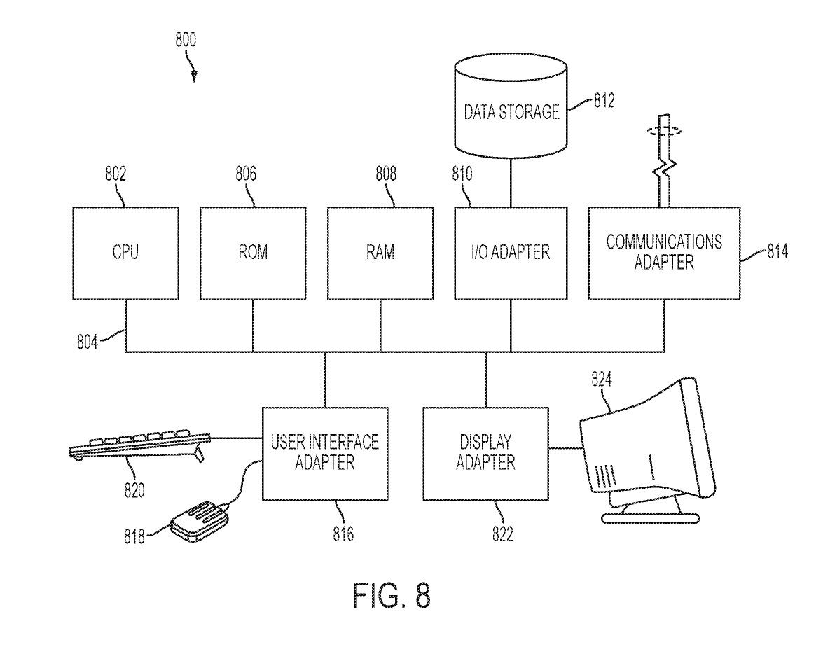

FIG. 8 is a schematic block diagram illustrating one embodiment of a computer system with processor that may execute certain embodiments of the optimization tool for designing composite panels. FIG. 8 illustrates a computer system 800 according to certain embodiments of a server and/or a user interface device, such as the computer 706 of FIG. 7. The central processing unit (CPU) 802 is coupled to a system bus 804. The CPU 802 may be a general purpose CPU or microprocessor. The present embodiments are not restricted by the architecture of the CPU 802, so long as the CPU 802 supports execution of the operations described herein, such as various addition and multiplication commands and vector and matrix operations. In some embodiments, the CPU 802 may be a graphics processing unit (GPU), general purpose graphics processing unit (GPGPU), multi-core processor, and/or an application-specific integrated circuit (ASIC). The CPU 802 may execute various logical instructions according to disclosed embodiments. For example, the CPU 802 may execute high-level computer code programmed to solve a MINLP model.

The computer system 800 may include Random Access Memory (RAM) 808, which may be SRAM, DRAM, SDRAM, or the like. The computer system 800 may utilize RAM 808 to store the various data structures used by a software application configured for behavioral clustering. The computer system 800 may also include Read Only Memory (ROM) 806 which may be PROM, EPROM, EEPROM, optical storage, or the like. The ROM may store configuration information for booting the computer system 800. The RAM 808 and the ROM 806 may hold user and/or system data.

The computer system 800 may also include an input/output (I/O) adapter 810, a communications adapter 814, a user interface adapter 816, and a display adapter 822. The I/O adapter 810 and/or user the interface adapter 816 may, in certain embodiments, enable a user to interact with the computer system 800 in order to input information such as materials requirements and/or material parameters. In a further embodiment, the display adapter 822 may display a graphical user interface associated with a software or web-based application for receiving input parameters for a MINLP model or displaying the optimized composite design that is output from the MINLP model.

The I/O adapter 810 may connect to one or more data storage devices 812, such as one or more of a hard drive, a Compact Disk (CD) drive, a floppy disk drive, a tape drive, to the computer system 800. The communications adapter 814 may be adapted to couple the computer system 800 to a network, which may be one or more of a wireless link, a LAN and/or WAN, and/or the Internet. The user interface adapter 816 couples user input devices, such as a keyboard 820 and a pointing device 818, to the computer system 800. The display adapter 822 may be driven by the CPU 802 to control the display on the display device 824.

Disclosed embodiments are not limited to the architecture of system 800. Rather, the computer system 800 is provided as an example of one type of computing device that may be adapted to perform functions of a server and/or a user interface device. For example, any suitable processor-based device may be utilized including, without limitation, personal data assistants (PDAs), computer game consoles, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the disclosed embodiments.

If implemented in firmware and/or software, the functions described above, such as with respect to the flow chart of FIG. 4 may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically erasable programmable read-only memory (EEPROM), compact-disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks, and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for designing a multiple ply layered composite, comprising:
receiving, by a processor, a plurality of input parameters specifying at least one material parameter of raw materials available for inclusion in the multiple ply layered composite and at least one material requirement of the multiple ply layered composite; and
selecting, by the processor, a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement,
wherein the step of selecting comprises:
solving a mixed integer nonlinear programming (MINLP) model by simultaneously considering the at least one material parameter and the characteristics of the individual layers and by predicting an aggregated stiffness of a composite having the considered at least one material parameter and the considered characteristics of the individual layers; and
optimizing a solution to the mixed integer nonlinear programming (MINLP) model to select the multiple ply layered composite meeting the at least one material requirement having a minimal areal weight.

2. The method of claim 1, further comprising manufacturing the multiple ply layered composite selected according to the optimized solution to the mixed integer nonlinear programming (MINLP) model.

3. The method of claim 1, wherein the step of optimizing a solution to the mixed integer nonlinear programming (MINLP) model comprises:
defining a vector of constraint functions, g and h, by selecting values for a vector of continuous decision variables, x, and a vector of binary decision variables, y,
wherein the constraint functions comprise functions for calculating the constitutive mechanical properties of each possible pair of fiber and matrix that can form an individual ply, functions for calculating a composite mechanical property, and/or a linear loading-deformation relation governing an aggregated mechanical response of the composite; and
defining an objective function, f, that is to be minimized while satisfying the constraint functions.

4. The method of claim 3, wherein:
the binary decision variables comprise presence or absence of a particular ply in the composite, total number of plies, thickness of each ply, fiber and resin material combination for each ply, and/or quadrant of a fiber orientation angle for each ply; and
the continuous decision variables comprise thickness and volume fraction of each ply, a vector of strains and curvatures experienced at a mid-plane of the composite, and/or variables to model certain trigonometric functions of the fiber orientation angle of each ply.

5. The method of claim 1, wherein:
the step of optimizing the solution comprises optimizing for multiple objectives, wherein the objectives comprise a physical attribute of the composite and/or a cost of the composite; and
the at least one physical attribute comprises a weight, a thickness, and/or a total fiber content of the multiple ply layered composite.

6. The method of claim 1, wherein the step of optimizing the solution comprises optimizing the solution with a branch-and-bound based global optimization solver executed by the processor.

7. The method of claim 1, wherein:
the at least one materials requirements comprises matrix, fiber, maximum strain, symmetric composite, balanced composite, ply thickness, maximum number of plies, in-plane forces, bending moments, twisting moments, strains, and/or deflections; and
the characteristics of individual layers comprise a thickness of each ply, a position of each ply relative to a mid-plane of the composite, an allowable volume fraction of fibers in each ply, and/or a fiber orientation angle in each ply.

8. The method of claim 1, wherein predicting the aggregated stiffness of the multiple ply layered composite comprises predicting the aggregated stiffness according to classical lamination theory (CLT).

9. The method of claim 1, wherein the step of optimizing the solution comprises predicting an aggregated stiffness of various composites comprising multiple fiber materials and multiple resin materials for each ply of the multiple ply layered composite.

10. The method of claim 1, wherein the step of optimizing the solution comprises selecting the one or more materials for the multiple ply layered composite and the characteristics of the individual layers of the multiple ply layered composite with the least weight among all the composites satisfying all the specified material requirements.

11. An apparatus, comprising:
a memory; and
a processor coupled to the memory, wherein the processor is configured to perform the steps of:
receiving a plurality of input parameters specifying at least one material parameter of raw materials available for inclusion in the multiple ply layered composite and at least one material requirement of the multiple ply layered composite; and
selecting a first choice of one or more materials for the multiple ply layered composite and a second choice of characteristics of individual layers within the multiple ply layered composite, wherein the individual layer characteristics comprise at least fiber volume fraction and fiber orientation, and wherein the first choice and the second choice meets the at least one material requirement,
wherein the step of selecting comprises:
solving a mixed integer nonlinear programming (MINLP) model by simultaneously considering the at least one material parameter and the characteristics of the individual layers and by predicting an aggregated stiffness of a composite having the considered at least one material parameter and the considered characteristics of the individual layers; and
optimizing a solution to the mixed integer nonlinear programming (MINLP) model to select the multiple ply layered composite meeting the at least one material requirement having a minimal areal weight.

12. The apparatus of claim 11, wherein the processor is further configured to perform the step of outputting a data file comprising a description of the first choice of one or more materials for the multiple ply layered composite and the second choice of characteristics of individual layers within the multiple ply layered composite, wherein the description comprises the optimized solution to the mixed integer nonlinear programming (MINLP) model.

13. The apparatus of claim 11, wherein the step of optimizing a solution to the mixed integer nonlinear programming (MINLP) model comprises:
defining a vector of constraint functions, g and h, by selecting values for a vector of continuous decision variables, x, and a vector of binary decision variables, y,
wherein the constraint functions comprise functions for calculating the constitutive mechanical properties of each possible pair of fiber and matrix that can form an individual ply, functions for calculating a composite mechanical property, and/or a linear loading-deformation relation governing an aggregated mechanical response of the composite; and
defining an objective function, f, that is to be minimized while satisfying the constraint functions.

14. The apparatus of claim 13, wherein:
the binary decision variables comprise presence or absence of a particular ply in the composite, total number of plies, thickness of each ply, fiber and resin material combination for each ply, and/or quadrant of a fiber orientation angle for each ply; and
the continuous decision variables comprise thickness and volume fraction of each ply, a vector of strains and curvatures experienced at a mid-plane of the composite, and/or variables to model certain trigonometric functions of the fiber orientation angle of each ply.

15. The apparatus of claim 11, wherein:
the step of optimizing the solution comprises optimizing for multiple objectives, wherein the objectives comprise a physical attribute of the composite and/or a cost of the composite; and
the at least one physical attribute comprises a weight, a thickness, and/or a total fiber content of the multiple ply layered composite.

16. The apparatus of claim 11, wherein the step of optimizing the solution comprises optimizing the solution with a branch-and-bound based global optimization solver executed by the processor.

17. The apparatus of claim 11, wherein:
the at least one materials requirements comprises matrix, fiber, maximum strain, symmetric composite, balanced composite, ply thickness, maximum number of plies, in-plane forces, bending moments, twisting moments, strains, and/or deflections; and
the characteristics of individual layers comprise a thickness of each ply, a position of each ply relative to a mid-plane of the composite, an allowable volume fraction of fibers in each ply, and/or a fiber orientation angle in each ply.

18. The apparatus of claim 11, wherein predicting the aggregated stiffness of the multiple ply layered composite comprises predicting the aggregated stiffness according to classical lamination theory (CLT).

19. The apparatus of claim 11, wherein the step of optimizing the solution comprises predicting an aggregated stiffness of various composites comprising multiple fiber materials and multiple resin materials for each ply of the multiple ply layered composite.

20. The apparatus of claim 11, wherein the step of optimizing the solution comprises selecting the one or more materials for the multiple ply layered composite and the characteristics of the individual layers of the multiple ply layered composite with the least weight among all the composites satisfying all the specified material requirements.
